(19) United States
(12) Patent Application Publication
(10) Pub. No.: US 2008/0054515 A1
(43) Pub. Date: Mar. 6, 2008

(54) Production method of polymer film and production apparatus of the same

(75) Inventors: Akifumi Kato, Kanagawa (JP); Hidekazu Yamazaki, Kanagawa (JP); Hitoshi Ikeda, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/896,840

(22) Filed: Sep. 6, 2007

(30) Foreign Application Priority Data
Sep. 6, 2006 (JP) 2006-241272

(51) Int. Cl. B29C 39/20

(52) U.S. Cl. 264/172.19; 425/102

(57) ABSTRACT

There is provided a casting drum having an outer peripheral surface provided with an electrical insulating layer. Direct-current high voltage is applied to an electrode bar disposed in an upstream side from a discharge port to discharge toward the casting drum. Bead is attracted to the charged casting drum by electrostatic attraction. Thereby, the adhesion between the bead and the casting drum is increased, and therefore the occurrence of phenomenon of air entrainment can be prevented. A wet film obtained by peeling a casting film from the casting drum is dried. Accordingly, it is possible to produce a film having few defects such as voids and high quality such as excellent smoothness at high speed and stably.

### FIELD OF THE INVENTION

The present invention relates to a production method of a polymer film and a production apparatus of the same.

### BACKGROUND OF THE INVENTION

On a surface of a polarizing filter as a main component of liquid crystal display (LCD), a polymer film for optical use such as a protective film for protecting a surface of the polarizing filter, a retardation film for eliminating optical distortion of light, and an antireflection film is used. In accordance with the sharp demand expansion of LCD, demand expansion of the polymer film also increases. In the following explanation, the polymer film is referred to as a film, and the polymer film for optical use is referred to as an optical film.

As a production method of a polymer film, there are used a solution casting method and a melt extrusion method in general. In the melt extrusion method, a polymer pellet is heated and melted to be extruded by an extruder, thus producing a film. The melt extrusion method is excellent in productivity and capable of producing film with use of a simple installation. However, the polymer is thermally damaged at the time of being heated and melted to cause deterioration of the transparency of the film, and it is difficult to produce a film having a uniform thickness. Accordingly, as the production method of an optical film requiring excellent transparency, the solution casting method predominates.

In the solution casting method, dope as a mixture containing a polymer, a solvent, and an additive is cast onto a moving support to form a casting film, and then the casting film is peeled from the support as a wet film to be dried, thus obtaining a film. In this method, it is important to produce a film having good quality such as excellent transparency and smoothness. The improvement in the productivity by making the film forming speed faster has been desired. As part of the improvement, it is attempted to make the casting speed of the dope faster. However, when the casting speed of the dope is made faster, bead as a flow of the dope between the discharge port and the support is subjected to air entrainment. Therefore, there arises a problem in which a void is generated in the casting film and evenness occurs on the surface thereof to deteriorate the smoothness of the film.

In view of the above, as a method of preventing air entrainment, for example, there is proposed a method in which static electrical charge is applied between bead and a support in Japanese Patent Laid-Open Publication No. 2001-113544. In this method, an electrode is disposed at the vicinity of the bead, that is, at the vicinity of the discharge port, and voltage is applied between the bead and the support with the oxygen concentration regulated. Additionally, there is proposed a method in which a suction chamber provided with a suction port having a plurality of sections with respect to the width direction of the bead is used and the pressure in each of the sections is controlled for commutation to decompress the vicinity of the bead as disclosed in Japanese Patent Laid-Open Publication No. 2002-103359.

However, according to Japanese Patent Laid-Open Publication No. 2001-113544, since the electrode is disposed at the vicinity of the bead, while forming films continuously, solvent vapor having vaporized form the bead or an additive adheres to the electrode, and an electrode deteriorates, thus resulting in difficulty in applying voltage. Accordingly, there arises decrease in the effect of preventing air entrainment in Japanese Patent Laid-Open Publication No. 2001-113544. Additionally, according to Japanese Patent Laid-Open Publication No. 2002-103359, only the suction chamber or the like is not sufficient to prevent occurrence of the phenomenon of air entrainment, and further, as the film forming speed is made faster, both side ends of bead heave and become unstable, and therefore there arises a problem in which a casting film may have poor smoothness.

### SUMMARY OF THE INVENTION

In view of the above, an object of the present invention is to provide a production method of a polymer film capable of forming a casting film while preventing occurrence of phenomenon of air entrainment to produce a film having few defects and excellent smoothness at high speed and stably.

According to the present invention, there is provided a production method of a polymer film including the steps of: discharging dope containing a polymer and a solvent from a casting die onto a support moving continuously, and casting a bead formed between the casting die and the support onto the support to form a casting film; drying the casting film peeled from the support as a film; and charging a surface of the support by a voltage applying device disposed at the vicinity of the surface of the support before formation of the casting film.

Preferably, the voltage applying device is an electrode body for applying charge to the support by discharging toward the support, and is disposed in an upstream side from the bead in a moving direction of the support.

An electrical insulating layer is preferably disposed on the surface of the support.

It is preferable that the surface potential V of the support is set to 0.1 kV≦|V|≦3 kV and that the casting is performed under an oxygen concentration of less than 10 wt %.

A suction chamber provided in an upstream side from the bead preferably decompresses a portion in the upstream side from the bead. The electrical insulating layer preferably has a multi-layer structure.

According of the present invention, there is provided a production apparatus of a polymer film including: a support moving continuously; a casting die for discharging a dope containing a polymer and a solvent onto the support to form a casting film; a voltage applying device for charging a surface of the support to be cast, the voltage applying device being disposed at the vicinity of the surface of the support; and a drying device for drying the casting film peeled from the support to form a polymer film.

According to the present invention, it is possible to form a casting film at high speed while attracting the bead to the surface of the support and preventing occurrence of the phenomenon of air entrainment. Further, it is possible to produce a film having few defects and excellent smoothness at high speed and stably by drying the casting film.

### BRIEF DESCRIPTION OF THE DRAWINGS

One with ordinary skill in the art would easily understand the above-described objects and advantages of the present invention when the following detailed description is read with reference to the drawings attached hereto:

FIG. 1 is a schematic diagram illustrating a film production apparatus according to an embodiment of the present invention;

FIG. 2A is a schematic diagram illustrating a dope casting section and its vicinity according to the embodiment of the present invention; and

FIG. 2B is an enlarged view of an area (b) surrounded by a dashed line in FIG. 2A.

### DESCRIPTION OF THE PREFERRED EMBODIMENTS

A production method of polymer film according to the present invention is explained in detail by referring to Embodiments.

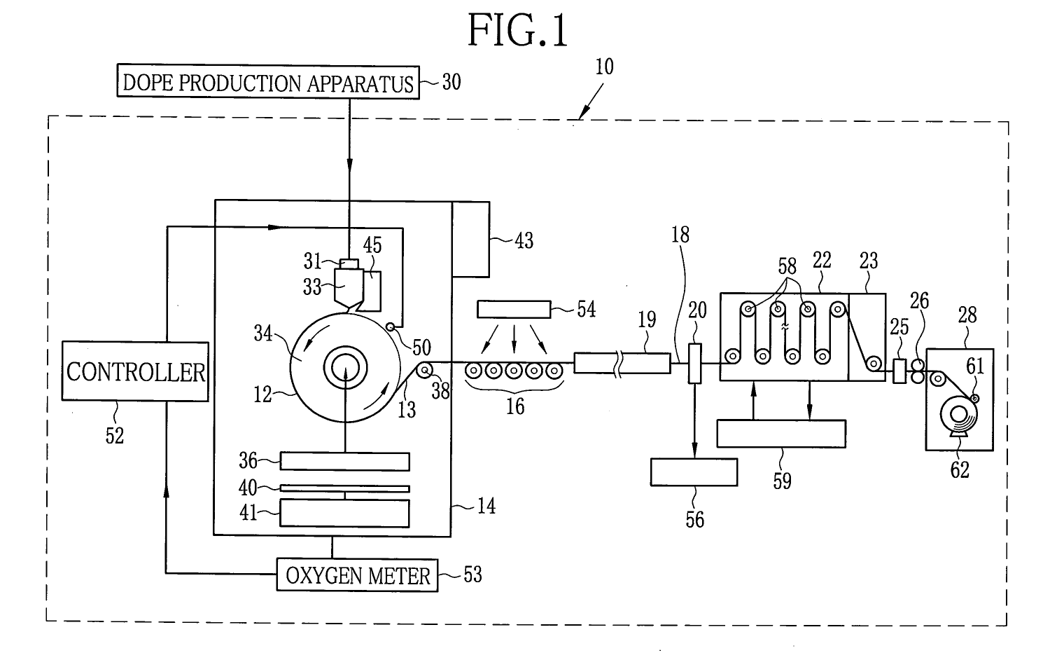

As shown in FIG. 1, the film production apparatus 10 includes a casting chamber 14, a transfer section 16, a tenter device 19, an edge slitting device 20, a drying chamber 22, a cooling chamber 23, a compulsory neutralization device 25, a knurling roller 26, and a winding chamber 28. Dope is cast onto a rotating support to form a casting film 12 in the casting chamber 14. The casting film 12 is peeled as a wet film 13 from the support and dried while being transferred in the transfer section 16. While both side ends of the wet film 13 are held by a fixing device and transferred, the drying of the wet film 13 is promoted to obtain a film 18 in the tenter device 19. Both side ends of the film 18 are cut away in the edge slitting device 20. The film 18 is sufficiently dried in the drying chamber 22. The film 18 after being dried is cooled in the cooling chamber 23. The compulsory neutralization device 25 adjusts voltage to be applied to the film 18. The knurling roller 26 applies knurling to the film 18. The film 18 is wound in a roll manner in the winding chamber 28. Note that the film production apparatus 10 is connected to a dope production apparatus 30 through a pipe as a flow channel of the dope, and an adequate amount of the dope is arbitrarily supplied from the dope production apparatus 30 to the film production apparatus 10.

The casting chamber 14 includes a feed block 31, a casting die 33, a casting drum 34, a heat transfer medium feeder 36, a peel roller 38, a condenser 40, and a recovery device 41. The dope is supplied from the dope production apparatus 30 to the feed block 31. The casting die 33 has a slit as a discharge port through which the dope is discharged onto the support. The casting drum 34 functions as the support. The heat transfer medium feeder 36 supplies heat transfer medium, whose temperature is adjusted, to the flow channel formed in the casting drum 34 in order to adjust a surface temperature of the casting drum 34. The wet film 13 peeled from the casting drum 34 is supported by the peel roller 38. Solvent vapor in the casting chamber 14 is condensed and liquidized by the condenser 40. The liquidized solvent is recovered by the recovery device 41. Additionally, a temperature regulator 43 for regulating the temperature inside the casting chamber 14 is attached outside the casting chamber 14.

The flow channel of the dope is formed in the feed block 31. It is possible to form the casting film 12 having a desired structure by adjusting the location of the flow channel. The casting die 33 is provided with a suction chamber 45. The suction chamber 45 is disposed in the upstream side from the bead formed from a discharge port of the casting die 33 to the casting drum 34. The suction chamber 45 is used to suck air and decrease pressure in order to decompress a upstream area from the bead as the dope from the discharge port to the casting drum 34. An outer surface of the suction chamber 45 is provided with a jacket (not shown) to flow the transfer medium whose temperature is adjusted and thus adjust the temperature inside the suction chamber 45. Since the temperature inside the suction chamber 45 is adjusted in this way, the solvent vapor having vaporized from the dope, the bead, and the casting film 12 is prevented from adhering to surface of the suction chamber 45.

Although the shape, material, size, and the like of the casting die 33 are not especially limited, a coat-hanger type die is preferably used as the casting die 33 in order to keep a width of the dope to be cast approximately constant. Further, the discharge port of the casting die 33 is preferably 1.1 to 2.0 times the width of the dope to be cast. As the material of the casting die 33, precipitation hardened stainless steel is preferably used in view of endurance, heat resistance, and the like. It is preferable that the material has resistance to corrosion such that pitting is not generated on a gas-liquid interface after being soaked in a mixed solution of dichloromethane, methanol, and water for three months. Further, it is also preferable that the resistance to corrosion is substantially equivalent to that of SUS316 subjected to a compulsory corrosion examination using an electrolyte aqueous solution. Note that a coefficient of thermal expansion thereof is preferably 2×10⁻⁵(° C.⁻¹) or less in view of heat resistance.

Preferably, a hardened film is formed on the lip edge of the discharge port for the purpose of improving resistance to wear and the like. A method for forming the hardened film is not especially limited, however there are ceramic coating, hard chrome-plating, nitriding treatment, and the like, for example. When the ceramic is used as the hardened film, it is preferable that the ceramic can be ground, has low porosity, and is excellent in strength and resistance to corrosion, while having excellent adhesion to the casting die 33 and poor adhesion to the dope. Concretely, there are tungsten carbide (WC), Al₂O₃, TiN, Cr₂O₃, and the like. Among those, WC is preferably used. Note that it is possible to perform WC coating by a well-known thermal spraying method.

In order to obtain the casting film 12 excellent in smoothness, the surface of the casting die 33, which contacts with the dope, is preferably ground or the like to be smooth. Additionally, it is preferable to provide an edge portion of the casting die 33 with a suction device (not shown) to suck the edge portion while the volume of sucked air is in the range of 1 L/min to 100 L/min. Thereby, it is possible to decrease air flow rate which may cause generation of unevenness on the surface of the bead.

The casting drum 34 is preferably capable of continuously rotating. Note that, although the support is the casting drum 34 in this embodiment, the support is not limited thereto. For example, as the support, it is preferable to use a casting band which is wound around a pair of rollers including one driving roller and moves continuously. Further, the size and the material of the support is not especially limited in accordance with its shape, however, the width of the support is preferably 1.1 to 2.0 times the width of the dope to be cast, and it is preferable to use stainless in view of resistance to corrosion, strength, and the like. Further, in order to form the casting film excellent in smoothness, the surface of the support is preferably ground as much as possible. In this embodiment, a drum made of stainless capable of rotating continuously by a driver (not shown) is used, and the drum is caused to rotate while the dope is cast.

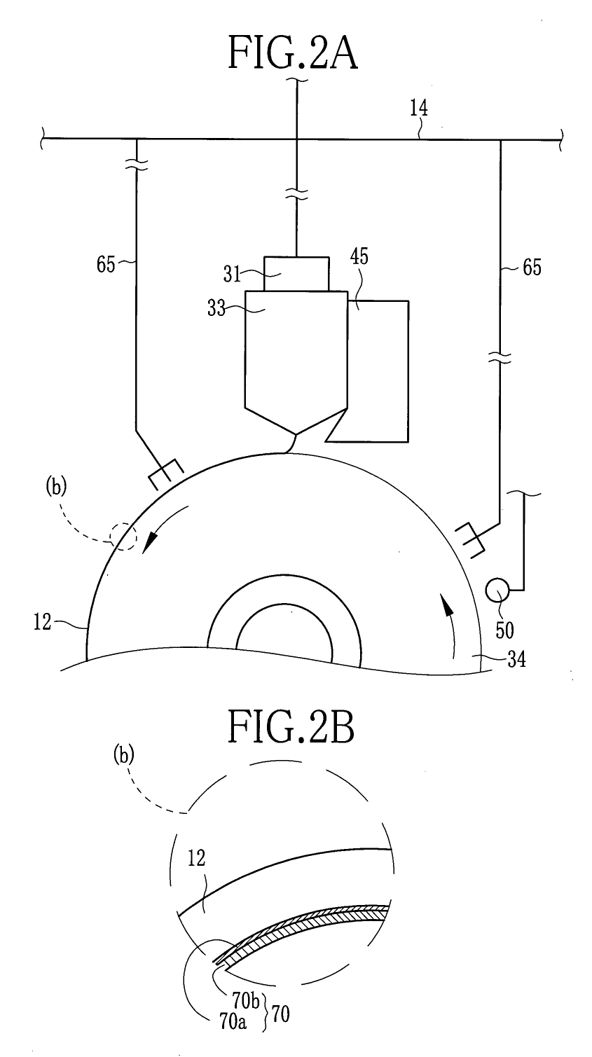

An electrode bar 50 as a voltage applying device is disposed in the upstream side from a spot where the bead reaches the casting drum 34. The length of the electrode bar 50 is approximately the same as the width of the casting drum 34. Direct-current high voltage is applied to the electrode bar 50 to discharge toward the casting drum 34. Thereby, the casting drum 34 is charged. Moreover, the casting chamber 14 includes a controller 52 and an oxygen meter 53. The oxygen meter 53 is used to constantly measure the oxygen concentration inside the casting chamber 14. Based on the measured value, the switching on and off of the electrode bar 50 is controlled. Note that, the electrode bar 50 has a shape of a rod extending along the width direction of the casting drum 34. Only one electrode bar having a length approximately the same as the width of the casting drum 34 is disposed as shown in FIG. 2A in this embodiment. However, another embodiment may be adopted. In another embodiment, a plurality of electrode bars each having a length approximately the same as the width of the casting drum 34 may be disposed in a feeding direction of the film. Thereby, it is possible to charge the surface of the drum with more uniform charge amount.

The transfer section 16 includes a plurality of rollers for supporting the wet film 13, and an air supplying device 54 for blowing dry air toward the wet film 13 to be transferred. The plurality of rollers may include transfer rollers. The tenter device 19 is provided with a pair of chains (not shown) having a pin plate and a temperature regulator (not shown) for regulating the temperature inside the tenter device 19. The pin plate has a plurality of pins as a fixing device for holding and fixing both side ends of the wet film 13. The pair of chains is wound around a pair of rails having a width gradually increasing from the inlet of the tenter device 19 to the outlet thereof, that is, from the upstream side to the downstream side. The chains move along the rail.

A crusher 56 for crushing the both side ends of the film 18 cut away into chips is connected to the edge slitting device 20. A plurality of rollers 58 and a temperature controller (not shown) are disposed in the drying chamber 22. The film 18 is wound around the plurality of rollers 58 and transferred with the support thereof. The temperature controller is used for controlling the temperature inside the drying chamber 22. Additionally, an adsorption and recovery device 59 for adsorbing and recovering the solvent vapor having vaporized from the film 18 is disposed outside the drying chamber 22. In the winding chamber 28, there is disposed a winding roller 62 provided with a press roller 61 for applying pressure to the film 18.

Next, a procedure for producing the film 18 with use of the film production apparatus 10 is concretely explained. First of all, the dope prepared in the dope production apparatus 30 is supplied to the casting die 33 thorough the feed block 31.

As shown in FIG. 2A, a labyrinth seal 65 is used for shielding the casting section including the casting die 33 having the discharge port of the dope and the suction chamber 45 in the casting chamber 14. Thus, it is possible to prevent the change in the surface of the bead due to wind generated in the casting chamber 14 in accordance with the rotating of the casting drum 34 or the like.

Discharging is performed toward the surface of the casting drum 34 before the casting by the electrode bar 50. The casting drum 34 having an outer surface provided with an electrical insulating layer 70 is used to charge the casting drum 34 positively or negatively. The dope discharged from the casting die 33 to the casting drum 34, that is, bead is attracted to the casting drum 34 by electrostatic attraction. Thereby, the adhesion between the bead and the casting drum 34 is increased to prevent air entrainment. Note that it is preferable to dispose the electrode bar 50 in the upstream side from the bead in the rotating direction of the casting drum 34. Accordingly, it is possible to reduce the possibility of decrease in charging effect that is caused by the solvent vapor in the casting chamber 14 adhered to the electrode bar 50. As in the case of this embodiment, when the electrode bar 50 is disposed outside the casting section shielded by the labyrinth seal 65, it is possible to further decrease the extent of adhesion of the solvent vapor to the electrode bar 50.

In order to efficiently prevent the air entrainment, it is preferable to set surface potential V of the casting drum 34 so as to satisfy a condition represented by 0.1 kV≦|V|≦3 kV. It is possible to readily control the surface potential V by adjusting the discharge amount from the electrode bar 50. When |V| is less than 0.1 kV, only weak sucking force is applied between the bead and the casting drum 34, and therefore it may be difficult to prevent the occurrence of the air entrainment. On the contrary, when |V| is more than 3 kV, the charge amount of the casting drum 34 becomes too large, and the bead may fluctuate. Additionally, in some cases, the charge amount may be nonuniform in the width direction of the casting drum 34. Further, when |V| is more than 3 kV, breakdown occurs in the electrical insulating layer 70 in some cases.

While forming the casting film 12, the oxygen concentration inside the casting chamber 14 is constantly measured by the oxygen meter 53, and the flow rate of nitrogen gas is adjusted based on the measured value such that the oxygen concentration inside the casting chamber 14 is always less than 10 wt %. Accordingly, the possibility of fire or explosion in the casting chamber 14 can be decreased. The oxygen concentration can be readily adjusted by supplying inert gas such as nitrogen gas and carbon dioxide, a mixed gas including inert gas and air, or the like to the casting chamber 14. Note that, when the oxygen concentration becomes 10 wt % or more for some reasons, an alarm is given and the discharging by the electrode bar 50 is stopped thorough the controller 52.

The charging method for the casting drum 34 is not especially limited, however it is preferable that the discharge treatment in the above manner is used to uniformly apply charge to the casting drum 34. The discharge treatment described above is known as direct current corona discharge. Note that it is preferable that all the charges to be applied to the casting drum 34 are unipolar charges. All the unipolar charges are uniformly negative or positive. Thus, it is possible to obtain strong force for attracting the bead.

The electrical insulating layer 70 is a layer, which exhibits electrical insulating properties, obtained by melting and depositing insulating substance or by other methods. Since the electrical insulating layer 70 is formed on the peripheral surface of the casting drum 34 on which the bead is cast, and the discharge treatment described above is applied thereto, it is possible to form a discharge path dendritically expanded along the surface of the electrical insulating layer 70 and charge the casting drum 34 made of stainless readily. Although the above insulating substance is not especially limited, there are: ceramic containing at least one of alumina, zirconia, chrome oxide, and titania, or containing a mixture having at least two of alumina, zirconia, chrome oxide, and titania; polytetrafluoroethylene (PTFE); and plastic, for example. The forming method and the thickness of the layer 70 are not also especially limited, however it is preferable that the layer 70 is formed such that the thickness is uniform on an entire surface of the casting drum 34. Note that the electrical insulating layer 70 according to this embodiment is obtained by depositing ceramics mainly containing alumina to form a layer.

Preferably, the electrical insulating layer 70 has a multi-layer structure rather than a single-layer structure. More preferably, the multi-layer structure includes a first layer 70a in contact with the casting film 12 and a second layer 70b formed on the first layer 70a and thicker than the first layer 70a, for example. In order to make the surface of the casting film 12 in contact with the first layer 70a smooth as much as possible, the exposed surface of the first layer 70a is preferably smooth. When the surface of the casting film 12 is rough, in many cases, the surface of the obtained film 18 (see FIG. 1) is also rough. In order to make the exposed surface of the first layer 70a made of ceramics smooth, the diameter of particles of ceramics as the material is preferably small. The same holds true for PTFE instead of ceramics as the material of the first layer 70a.

In a case where the diameter of particles of ceramics or PTFE for use in the first layer 70a is made shorter, the first layer 70a is more easily broken or tends to take on cracks. The tendency described above becomes more remarkable as the thickness of the first layer 70a becomes thicker for the purpose of imparting electrical insulating properties to the peripheral surface of the casting drum 34. In view of the above, the second layer 70b is formed on the first layer 70a. Namely, the second layer 70b is a layer in contact with the casting film 12, and not exposed to the outside. The diameter of the particles of ceramics or PTFE in the second layer 70b is made larger than that in the first layer 70a. Thereby, the electrical insulating layer 70 has smoothness and no cracks, and is not easily broken by a long-term use. Further, since the electrical insulating layer 70 has a multi-layer structure including the first layer 70a and the second layer 70b made from the materials as describe above, the exposed surface can be smooth, and the electrical insulating properties can be strong. Note that plural second layers 70b may be formed so as to be stacked on one another.

At the time of casting, the suction chamber 45 is used to set the pressure in the upstream area from the bead to a level lower than atmospheric pressure. Accordingly, the bead is attracted to the upstream area therefrom, namely, toward the casting drum 34, and it becomes possible to further prevent the air entrainment and decrease the flow rate of the air at the vicinity of the bead. Therefore, it is possible to cast the bead while preventing the change in the surface of the casting film. Moreover, as described above, since the casting section is shielded by the labyrinth seal 65, it is possible to efficiently decrease the pressure at the vicinity of the bead by the suction chamber 45. Note that the pressure of the upstream area from the bead is preferably in the range of (AP (atmospheric pressure)−2000 Pa) to (AP−10 Pa).

The surface temperature of the casting drum 34 is approximately constant in the range of −40° C. to 30° C. In this embodiment, the heat transfer medium whose temperature is adjusted is supplied from the heat transfer medium feeder 36 to the flow channel formed in the casting drum 34 to set the surface temperature of the casting drum 34 at −10° C. Further, at the time of casting, the temperature of the dope is preferably approximately constant in the range of −10° C. to 55° C. It is possible to adjust the temperature of the dope by controlling the internal temperature of the feed block 31 and casting die 33, and in this embodiment, the temperature of the dope is set to −5° C. Thereby, the bead is efficiently cooled on the casting drum 34, and the casting film 12 in a gel-like state is formed in a short time of period.

An air knife may be also used as an adhesion device for adjusting the extent of adhesion between the casting drum 34 and the casting film 12. When the air knife is used, it is preferable to blow the air against the casting film 12 formed in a downstream area from the bead in the rotating direction of the casting drum 34. Thereby, the bead is pressed onto the casting drum 34 and the extent of adhesion therebetween is enhanced. It is possible to adequately adjust the extent of adhesion between the casting film 12 and the surface of the casting drum 34 by controlling the speed and flow rate of the air blown against the casting film 12.

It is preferable that a solvent supplying device (not shown) is attached to an end portion of the discharge port of the casting die 33 in order to supply a desired solvent to the gas-liquid interface between the both side ends of the bead and ambient air and between the discharge port and the ambient air. The solvent is preferably capable of dissolving the dope, and as the solvent there are a mixed solvent of 86.5 parts by weight of dichloromethane, 13 parts by weight of methanol, and 0.5 parts by weight of n-butanol, for example. Thereby, it is possible to prevent the dope from being partially dried and solidified, and form the bead having a stable shape. In addition to this, it is also possible to decrease the possibility in which the solidified dope as a foreign substance is mixed with the bead and the casting film 12. Therefore, the film 18 having no defects and excellent transparency can be obtained. Moreover, in supplying the mixture described above, it is preferable to use a pump having a pulsation rate of 5% or less such that the supplying amount of the mixture is in the range of 0.1 mL/m to 1.0 mL/m at each end portion of the discharge port.

The solvent vapor in the casting chamber 14 is condensed and liquidized by the condenser 40 to be recovered by the recovery device 41. Thereby, the effect of decreasing the solvent vapor in the casting chamber 14 can be achieved. The recovered solvent is refined as a solvent for preparing the dope by a refining device (not shown) and reused. Thereby, it is possible to achieve reduction in cost of the material. Note that the temperature inside the casting chamber 14 is preferably approximately constant in the range of −10° C. to 57° C. by the temperature regulator 43.

The casting film 12 on the casting drum 34 is cooled and turned into a gel-like state more and more as time passes. The casting film 12 after being turned into a gel-like state and having a self-supporting property is peeled from the casting drum 34 with the support of the peel roller 38. A residual amount of the solvent in the casting film 12 just after being peeled off is preferably in the range of 10 mass % to 200 mass %. As for the residual amount of the solvent, the solvent is main solvent contained in a sample such as the casting film and the film as a target. However, when various solvents are contained in the sample, the solvent whose amount is greatest in the film is regarded as the main solvent. The residual amount of the solvent is determined on a dry basis, and a value calculated by a formula: [(x−y)/y]×100, in which x is weight of the film at the time of sampling and y is weight of the sampling film after being dried completely.

The casting film 12 thus peeled off is sent to the transfer section 16. In the transfer section 16, a dry air is blown against the casting film 12 from the air supplying device 54 while the casting film 12 is transported with the support of the plurality of the transporting rollers, thus promoting the drying of the casting film 12. The temperature of the dry air is set to approximately constant in the range of 20° C. to 250° C., and therefore it is possible to efficiently dry the casting film 12 without thermally damaging the casting film 12. Further, the rotation speed of each of the transporting rollers is set to be faster from the inlet side of the transfer section 16 to the outlet side thereof. Thereby, it becomes possible to transfer the casting film 12 in the transfer section 16 while applying appropriate tensile force thereto without causing wrinkles on the surface of the casting film 12.

After the drying of the casting film 12 proceeds, the casting film 12 is sent to the tenter device 19, and both side ends of the casting film 12 are fixed by being pierced by a plurality of pins at the vicinity of an inlet of the tenter device 19. The temperature inside the tenter device 19 is preliminarily controlled by a temperature regulator (not shown). Since the rail is disposed such that its width increases from the inlet of the tenter device 19 toward the outlet thereof, the casting film 12 is gradually extended in the width direction while being transferred along the rail. Thereby, the molecular orientation in the width direction of the casting film 12 is controlled and the drying thereof proceeds, to obtain the film 18 exhibiting high retardation value. Note that instead of extending and stretching the casting film 12 with use of the rail, a contracting device may be used to stretch the casting film 12 in the width direction. At the vicinity of the outlet of the tenter device 19, the fixation of the film 18 by the pins is released. Further, in this embodiment, a pin-tenter device having pins is used as a fixing device, however the fixing device is not limited thereto. As long as both side ends of the film can be held, a clip-tenter device provided with a plurality of clips for holding both side ends of the casting film 12 may be used as the fixing device.

Both side ends of the film 18 transferred from the tenter device 19 are cut off by the edge slitting device 20. Thereby, punctures of both side ends of the film 18 formed by the pins are removed. Note that the slitting process may be omitted, however the slitting process is preferably performed in any one of sections from the casting chamber 14 to the winding chamber 28 in order to obtain the film 18 having few defects.

The film 18 is sent to the drying chamber 22. While the film 18 is transferred with the support of the plurality of rollers 58, the film surface temperature of the film 18 is controlled to be constant in the range of 60° C. to 145° C. by using a temperature controller (not shown). Thereby, the drying of the film 18 is promoted without being thermally damaged. The film surface temperature of the film 18 is confirmed easily by checking temperature indicators (not shown) disposed on a transfer path of the film 18 and the vicinity of the surface of the film 18. Moreover, in the drying chamber 22, after the solvent vapor from the film 18 is recovered by the adsorption and recovery device 59, the solvent component is removed therefrom, and again supplied as dry air to the drying chamber 22. Thereby, solvent vapor is not adhered to the surface of the film 18 to achieve reduction in energy cost.

The film 18 is sent to the cooling chamber 23 and cooled until its temperature becomes approximately room temperature. The cooling method is not especially limited. For example, there may be used a method in which the film 18 is left in the cooling chamber 23 having the temperature adjusted to the room temperature to be cooled by natural cooling, or a method in which the film 18 is cooled with use of an air blower for supplying cool air attached to the cooling chamber 23. Note that it is preferable that a humidity control chamber (not shown) is disposed between the drying chamber 22 and the cooling chamber 23, and the film 18 after being subjected to humidity control is cooled, since the effect of efficiently stretching wrinkles formed on the surface of the film 18 can be achieved.

The voltage to be applied to the film 18 having temperature adjusted to approximately room temperature is adjusted by the compulsory neutralization device 25. The voltage to be applied to the film 18 is not especially limited, however the voltage to be applied to the film 18 is preferably approximately constant in the range of −3 kV to 3 kV. Thereafter, the knurling is applied on the both side ends of the film 18 by the knurling roller 26. Lastly, the film 18 is sent to the winding chamber 28, and wound by the winding roller 62 while its smoothness is adjusted by being applied with pressure on the surface thereof by the press roller 61. The tensile force at the time of winding of the film 18 is preferably gradually changed during the winding operation. Thereby, it becomes possible to wind the film 18 without generating wrinkles.

As described above, it is possible to produce the film 18 excellent in smoothness at high speed and stably. According to the present invention, it is possible to produce the film 18 having the length of at least 100 m or more in the feeding direction thereof, and 1400 mm to 2500 mm in the width direction thereof. However, in the present invention, even if the length of the film 18 is more than 2500 mm, it is possible to achieve effective result. Although the thickness of the obtained film 18 is not especially limited, the thickness of the obtained film 18 is preferably in the range of 20 μm to 500 μm, more preferably in the range of 30 μm to 300 μm, and most preferably in the range of 35 μm to 200 μm. However, in the present invention, even if the thickness of the film 18 is as thin as 15 μm to 100 μm, it is possible to achieve effective result.

Note that the method of charging the casting drum 34 is not limited to this embodiment. For example, a method using a friction member may be adopted. In this case, the casting drum 34 can be charged by causing the friction member to contact with the casting drum 34 to generate static electrical charge. As the friction member, there are a metal bar having the surface wrapped with fabric, a belt, a rubber product, and the like, for example, and the friction member is not especially limited thereto. However, it is preferable to select a suitable material in order to suppress damage of the surface of the casting drum 34 to the minimum extent, and to arbitrarily adjust the pressure to be applied at the time of contacting the friction member with the casting drum 34.

Although a film of single-layer structure is produced using one kind of dope in this embodiment as described above, the present invention is also effective in forming a casting film of multiple-layer structure. Note that a casting film of multiple-layer structure may be produced by a well-known method in which the desired number of dopes are cast simultaneously or sequentially, or other methods, and the method is not especially limited thereto. Further, the casting die, the suction chamber, a structure of the support or the like, co-casting, the peeling method, stretching, the drying condition in each process, the handling method, curling, the winding method after correcting smoothness, the solvent recovering method, and the film recovering method are described in detail in paragraphs [0617] to [0889] in Japanese Patent Laid-Open Publication No. 2005-104148. The description is also applicable to the present invention. Note that the properties of the obtained film, the extent of curling, thickness, and the measuring method thereof are described in paragraphs [1073] to [1087] in Japanese Patent Laid-Open Publication No. 2005-104148. The description is also applicable to the present invention.

At least one of the surfaces of the obtained film is preferably subjected to a surface treatment since the extent of adhesion between the surface of the film and an optical member such as a polarizing filter can be increased by the surface treatment. The surface treatment is preferably at least one of vacuum glow discharge, plasma discharge under the atmospheric pressure, UV-light irradiation, corona discharge, flame treatment, acid treatment, and alkali treatment.

When the obtained film is used as the base film and both surfaces or one surface thereof is provided with a desired functional layer, the resultant can be used as various functional layers. As the functional layer, there are an antistatic layer, a hardened resin layer, antireflection layer, an easily adhesive layer, an antiglare layer, and an optical compensation layer, and the like, for example. It is possible to obtain an antireflection film capable of preventing reflection of light and providing high image quality by providing the antireflection layer, for instance. Note that the above functional layers and the manufacturing method thereof are described in detail in paragraphs [0890] to [1072] in Japanese Patent Laid-Open Publication No. 2005-104148. The description is also applicable to the present invention. Additionally, as for a concrete application of the polymer film of the present invention, for example, there is application to a liquid crystal displays of TN type, STN type, VA type, OCB type, reflective type, and other types described in paragraphs [1088] to [1265] in Japanese Patent Laid-Open Publication No. 2005-104148.

Next, various materials of the dope of the present invention are explained in detail.

It is preferable to use cellulose ester as the material of dope, because it is possible to obtain a film having excellent transparency. As cellulose ester, for example, there is lower fatty acid ester including cellulose such as cellulose triacetate, cellulose acetate propionate, and cellulose acetate butyrate. Among them, in view of its level of transparency, cellulose acylate is preferably used, and triacetyl cellulose (TAC) is especially preferably used. Note that the dope used in this embodiment includes triacetyl cellulose (TAC) as the polymer. In a case where TAC is used as described above, at least 90 wt % of TAC particles have a diameter in the range of 0.1 mm to 4.0 mm, respectively. Note that the polymer fort the dope is not limited to cellulose ester, and may be any well-known substance as long as the substance can be dissolved into the solvent and serve as a dope.

In cellulose acylate describe above, in order to obtain a film having more excellent transparency, it is preferable that the degree of the acyl substitution for hydrogen atoms in hydroxyl groups in cellulose satisfies all of the following formulae:

2.5≦A+B≦3.0 (a)

0≦A≦3.0 (b)

0≦B≦2.9 (c)

In the above formulae (a) to (c), the A represents a degree of substitution of the hydrogen atom in the hydroxyl group to the acetyl group in cellulose, while the B represents a degree of substitution of the hydrogen atom in the hydroxyl group to the acyl group with 3 to 22 carbon atoms in cellulose.

Cellulose has glucose units making β-1,4 bond, and each glucose unit has a liberated hydroxyl group at second, third, and sixth positions. Cellulose acylate is a polymer in which a part of or the whole of the hydroxyl groups are esterified so that the hydrogen is substituted by the acyl group with two or more carbons. The degree of substitution for the acyl groups in cellulose acylate means a degree of esterification of the hydroxyl group at each of the second, the third, and the sixth positions in cellulose. Note that when the whole (100%) of the hydroxyl group at the same position is substituted, the degree of substitution at this position is 1.

The total degree of substitution for the acyl groups, namely DS2+DS3+DS6, is preferably in the range of 2.00 to 3.00, more preferably in the range of 2.22 to 2.90, and most preferably in the range of 2.40 to 2.88. In addition, DS6/(DS2+DS3+DS6) is preferably at least 0.28, more preferably at least 0.30, and most preferably in the range of 0.31 to 0.34. Note that DS2 is the degree of substitution of the hydrogen atom in the hydroxyl group at second position per glucose unit to the acyl group, DS3 is the degree of substitution of the hydrogen atom in the hydroxyl group at third position per glucose unit to the acyl group, and DS6 is the degree of substitution of the hydrogen atom in the hydroxyl group at sixth position per glucose unit to the acyl group.

In the present invention, the kind of the acyl groups in cellulose acylate can be one or more. When two or more kinds of acyl groups are in cellulose acylate, it is preferable that one of them is the acetyl group. When a total degree of substitution of the hydroxyl group at the second, the third, and the sixth positions to the acetyl groups and that to acyl groups other than acetyl groups are described as DSA and DSB, respectively, the value of DSA+DSB is preferably in the range of 2.22 to 2.90, and more preferably in the range of 2.40 to 2.88.

In addition, DSB is preferably at least 0.30, and more preferably at least 0.7. In the DSB, the percentage of the substitution of the hydroxyl group at the sixth position is preferably at least 20%. The percentage is more preferably at least 25%, further more preferably at least 30%, and most preferably at least 33%. Furthermore, the value of DSA+DSB, in which the hydroxyl group is at the sixth position in cellulose acylate, is preferably at least 0.75, more preferably at least 0.80, and most preferably at least 0.85. By using the cellulose acylate that satisfies the above conditions, dope with very excellent solubility can be prepared. Note that in a case where the cellulose acylate described above is used, since using a non-chlorine organic solvent represents excellent solubility, it is possible to produce the dope with low viscosity and excellent filterability.

Although cellulose as a material of cellulose acylate may be obtained from either linter cotton or pulp cotton, the linter cotton is preferably used.

According to the present invention, as for cellulose acylate, the acyl group having at least 2 carbon atoms may be either aliphatic group or aryl group, and is not especially limited. As examples of the cellulose acylate, there are alkylcarbonyl ester, alkenylcarbonyl ester, aromatic carbonyl ester, aromatic alkylcarbonyl ester, and the like. Cellulose acylate may be also esters having other substituents. Preferable substituents are, for example, propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphthylcarbonyl group, cinnamoyl group, and the like. Among them, more preferable groups are propionyl group, butanoyl group, dodecanoyl group, octadecanoyl group, t-butanoyl group, oleoyl group, benzoyl group, naphtyl carbonyl group, cinnamoyl group, and the like. Particularly, propionyl group and butanoyl group are most preferable.

A description about cellulose acylate is described in paragraphs [0140] to [0195] in Japanese Patent Laid-Open Publication No. 2005-104148. The description is also applicable to the present invention.

According to the present invention, the solvent to be used for preparing the dope is preferably an organic compound that can dissolve the polymer to be used. However, in the present invention, the dope means a mixture obtained by dissolving or dispersing the polymer into the solvent, and therefore the solvent having low dissolubility to the polymer also can be used. As such a preferable solvent, there are aromatic hydrocarbon (for example, benzene, toluene, and the like), halogenated hydrocarbon (for example, dichloromethane, chloroform, chlorobenzene, and the like), alcohol (for example, methanol, ethanol, n-propanol, n-butanol, diethylene glycol, and the like), ketone (for example, methanol, methylethyl ketone, and the like), ester (for example, methylacetate, ethylacetate, propylacetate, and the like), ether (for example, tetrahydrofuran, methylcellosolve, and the like), and the like. A mixture solvent including at least two kinds of solvents selected from these solvents may be used. Among them, dichloromethane is preferable because it is possible to obtain dope having excellent solubility and volatilize the solvent from the casting film in a short period of time, thus producing a film.

Preferably, the halogenated hydrocarbon has 1 to 7 carbon atoms. In view of physical properties, such as solubility to the polymer, peelability from the support of the casting film, a mechanical strength of the film, and optical properties, it is preferable to use at least one kind of alcohol having 1 to 5 carbon atoms together with dichloromethane. The content of alcohol is preferably in the range of 2 wt % to 25 wt %, and more preferably in the range of 5 wt % to 20 wt % relative to the whole solvent. Applicable alcohols are, for example, methanol, ethanol, n-propanol, iso-propanol, n-butanol, and the like, and especially methanol, ethanol, n-butanol, and a mixture of them are more preferable among them.

Recently, in order to suppress adverse influence on the environment to minimum extent, a solvent containing no dichloromethane is proposed. In this case, the solvent preferably contains ether with 4 to 12 carbon atoms, ketone with 3 to 12 carbon atoms, ester with 3 to 12 carbon atoms, or an appropriate mixture of them. Note that ether, ketone, and esther may have a cyclic structure, and a compound having at least two functional groups thereof (that is, —O—, —CO—, and —COO—) may be used as the solvent. The solvent may have other functional groups such as alcoholic hydroxyl groups. In using the solvent having two or more functional groups, the number of carbon atoms should be within a regulation range of the compound having one of the functional groups, and the number is not especially limited.

Various well-known additives such as a plasticizer, a UV-absorbing agent, deterioration inhibitor, a lubricant, and a release promoting agent may be added to the dope in accordance with the purpose. For example, as the plasticizer, there may be used various well-known plasticizers including phosphoric acid ester plasticizer such as triphenyl phosphate and biphenyl diphenyl phosphate, phthalic acid ester plasticizer such as diethylphthalate, and polyester polyurethane elastomer.

Further, for the purpose of preventing adhesion between the films and adjusting refractive index, fine particles are preferably added to the dope. Silicon dioxide derivatives are preferably used as the fine particles. In the present invention, silicon dioxide derivatives include silicon dioxide and silicone resin having three-dimensional web formation. The surface of the silicon dioxide derivatives described above is preferably subjected to an alkylation process. Since the fine particles subjected to a hydrophobic treatment such as the alkylation process are excellent in dispersibility to the solvent, it is possible to prepare the dope without causing aggregation of the fine particles and further produce the film. Therefore, it is possible to produce the film having few surface defects as well as excellent transparency.

As fine particles having the surface subjected to the alkylation process as described above, AEROSIL R805 (manufactured by NIPPON AEROSIL CO., LTD.) that is available as silicon dioxide derivatives each having a surface including octyl group, or the like may be used, for example. Note that for the purpose of keeping the effect of adding the fine particles and obtaining the film excellent in transparency, the content of the fine particles in the dope based on the solid content is preferably set to 0.2% or less. Further, the average diameter of the fine particles is preferably equal to or less than 11.0 μm, more preferably in the range of 0.3 μm to 1.0 μm, most preferably in the range of 0.4 μm to 0.8 μm such that the passage of light is not prevented by the fine particles.

As explained heretofore, according to the present invention, it is preferable that TAC is used as the polymer to prepare the dope for the purpose of obtaining the polymer film having excellent transparency. In this case, the concentration of TAC relative to the total amount of the dope after being mixed with the solvent, the additive, and the like is preferably in the range of 5 wt % to 40 wt %, more preferably in the range of 15 wt % to 30 wt %, and most preferably in the range of 17 wt % to 25 wt %. Additionally, the concentration of the additive (mainly a plasticizer) is preferably in the range of 1 wt % to 20 wt % relative to the whole solid content including the polymer and other additives in the dope.

Note that the solvent, various additives such as a plasticizer, a UV-absorbing agent, a deterioration inhibitor, a lubricant, a release promoting agent, an optical anisotropy controller, a retardation controller, dye, and a release agent, and the fine particles are described in detail in paragraphs to [0516] in Japanese Patent Laid-Open Publication No. 2005-104148. The description is also applicable to the present invention. Further, a dope production method using TAC including a dissolving method and an adding method of the materials and additives, a filtration method, and a defoaming method are also described in detail in paragraphs [0517] to [0616] in Japanese Patent Laid-Open Publication No. 2005-104148. The description is also applicable to the present invention.

Hereinafter, the present invention is described in detail referring to Examples and Comparative Examples. However, the present invention is not limited to those Examples and Comparative Examples.

### EXAMPLE 1

The film production apparatus 10 shown in FIG. 1 was used to produce the film 18. After an adequate amount of the dope was supplied from the dope production apparatus 30 to the casting die 33 through the feed block 31, the dope was discharged from the discharge port of the casting die 33 to the casting drum 34 continuously rotated as shown in FIG. 2A. At this time, the pressure in the suction chamber 45 was set to 600 Pa to decompress an upstream area from the bead. The discharge amount of the dope was adjusted such that the thickness of the film 18 after being dried became 80 μm.

The casting drum 34 was made of stainless and capable of controlling its rotational frequency by a driver (not shown). The heat transfer medium for cooling was supplied from the heat transfer medium feeder 36 to the casting drum 34 such that the surface temperature of the casting drum 34 became −10° C. As shown in FIG. 2A, before casting the dope, direct-current high voltage was applied to the electrode bar 50 for discharging, such that the casting drum 34 was charged. Surface potential V of the casting drum 34 was 1 kV. Further, nitrogen gas was supplied into the casting chamber 14 such that the oxygen concentration was constantly regulated at a level of less than 10 wt %. The temperature regulator 43 was used to constantly keep the temperature inside the casting chamber 14 at 35° C. Note that the casting die 33 was provided with a slit as a discharge port with the width of 1.8 m and a jacket (not shown) for controlling the temperature therein, and thereby the temperature of the dope to be cast was set to 36° C. The feed block 31 and the pipe as the flow channel of the dope had a temperature controlling function such that the temperatures therein were set at 36° C., respectively.

The casting film 12 after being cooled and turned into a gel-like state to have a self-supporting property was peeled from the casting drum 34 with the support of the peel roller 38, thus obtaining the wet film 13. Next, the wet film 13 was sent to the transfer section 16. While being transferred with the support of the plurality of transporting rollers, the wet film 13 was dried by dry air with the temperature adjusted at 40° C. supplied from the air supplying device 54. Thereafter, the wet film 13 was sent to the pin-type tenter device 19 and fixed by being pierced at its both side ends by a plurality of pins. Then, while being transferred, the wet film 13 was stretched in the width direction and dried by dry air supplied from a drier (not shown), thus obtaining the film 18.

The edge slitting device 20 was provided with a NT-type cutter. The NT-type cutter was disposed in a portion to which it took 30 seconds or less from the outlet of the tenter device 19. The edge slitting device 20 cut off the film 18 at a portion 50 mm away from each of the side ends of the film 18 toward the inward. Further, the both side ends of the film 18 thus cut off were sent to the crusher 56 by a cutter blower (not shown) to be crushed into chips each of which was approximately 80 mm² on average.

A preliminary drying chamber (not shown) was disposed between the edge slitting device 20 and the drying chamber 22 to preheat the film 18 by supplying dry air at the temperature of 100° C. thereto. Then the film 18 was sent to the drying chamber 22. In the drying chamber 22 whose inside temperature was adjusted by a temperature controlling device (not shown) such that the film surface temperature of the film 18 became 140° C., the film 18 was dried while being transferred by being wound around the plurality of rollers 58. The film 18 was dried in the drying chamber 22 for 10 minutes. The film surface temperature of the film 18 was measured by thermometers (not shown) provided in a portion which was just above a transfer path and at the vicinity of the surface of the film 18. In the drying chamber 22, the solvent vapor was recovered from the film 18 by using the adsorption and recovery device 59 having an absorbing agent of activated carbon and desorbing agent of dry nitrogen. Then, moisture was removed such that the water content of the recovered solvent vapor became 0.3 wt % or less.

Further, a humidity control chamber (not shown) was disposed between the drying chamber 22 and the cooling chamber 23. After air at the temperature of 50° C. and at the dew point of 20° C. was supplied to the film 18, air at the temperature of 90° C. and at the degree of humidity of 70% was directly supplied to the film 18, thus controlling the humidity thereof. Accordingly, the extent of curling generated on the film 18 was corrected. Next, the film 18 was sent to the cooling chamber 23 and gradually cooled therein until the temperature of the film 18 became 30° C. or less. Thereafter, the voltage applied to the film 18 was set to not less than −3 kV and not more than 3 kV by the compulsory neutralization device 25. Additionally, the knurling roller 26 was used to apply knurling on the both side ends of the film 18 to correct unevenness generated on the surface of the film 18. Note that the width of the film 18 subjected to the knurling was set to 10 mm, and pressure applied by the knurling roller 26 was regulated such that a height of the evenness was higher than the average height of the film 18 by 12 μm on average. Thereby, the embossing was applied to the film 18.

The film 18 was sent to the winding chamber 28, and wound by the winding roller 62 having a diameter of 169 mm while applying pressure of 50N/m to the film 18 by the press roller 61. At the time of starting winding the film 18, the tensile force was set to 300N/m, and at the time of finishing winding, the tensile force was set to 200N/m. As a result, a roll of product of the film 18 was obtained. The thickness of the obtained film 18 was 80 μm. Further, through the entire processes, the average drying speed of the wet film 13 and the film 18 was set to 20 wt %/m.

The materials of the dope used in this embodiment are described hereinafter.

[Materials of the dope]

| | | |
|---|---|---|
| cellulose triacetate | 100 | parts by weight |
| dichloromethane | 320 | parts by weight |
| methanol | 83 | parts by weight |
| 1-butanol | 3 | parts by weight |
| plasticizer A | 7.6 | parts by weight |
| plasticizer B | 3.8 | parts by weight |
| UV agent a | 0.7 | parts by weight |
| UV agent b | 0.3 | parts by weight |
| citric acid ester compound | 0.006 | parts by weight |
| fine particles | 0.05 | parts by weight |

Cellulose triacetate described above is a powder having degree of substitution of 2.84, viscosity average polymerization degree of 306, water content of 0.2 wt %, viscosity in dichloromethane solution of 6 wt % of 315 mPa·s, average particle diameter of 1.5 mm, and standard deviation of particle diameter of 0.5 mm. The plasticizer A is triphenyl phosphate. The plasticizer B is diphenyl phosphate. The UV agent a is 2(2′-hydroxy-3′,5′-di-tert-butylphenyl) benzotriazole. The UV agent b is 2(2′-hydroxy-3′,5′-di-tert-amylphenyl)-5-chlorbenzotriazole. The citric acid ester compound is a mixture including citric acid, monoethyl ester, diethyl ester, and triethyl ester. The fine particles are silicon dioxide having average particle diameter of 15 nm, and Mohs hardness of approximately 7. Further, in preparing the dope, a retardation controller (N—N-di-m-toluoyl-N-p-methoxyphenyl-1,3,5-triazine-2,4,6-triamine) was added such that its rate of content became 4.0 wt % relative to the total wt % of a film produced by the dope.

In order to evaluate the effect of the present invention, occurrence of the phenomenon of air entrainment in the bead was observed with eyes. Namely, the casting speed of the dope at which the phenomenon of air entrainment was observed was checked while speeding up the casting speed. As a result, in Example 1, the phenomenon of air entrainment was not confirmed until the casting speed became 120 m/min.

### EXAMPLES 2 TO 14 AND COMPARATIVE EXAMPLE 1

The surface of the casting drum 34 was charged such that surface potential V of the casting drum 34 exhibits a value shown in each section of Examples 2 to 14 in Table 1, and the occurrence of the phenomenon of air entrainment in the bead was observed in the same manner as Example 1. Note that Comparative Example 1 is a comparative example against the present invention, and no electrode bar 50 was used and the surface of the casting drum 34 was not charged in Comparative Example 1. Therefore, the surface potential V of the casting drum 34 is zero in Comparative Example 1. The value in each section in the column of “casting speed” in Table 1 is a casting speed at which occurrence of the phenomenon of air entrainment in the bead was observed after making the casting speed faster, as in the case of Example 1. Conditions in Examples 2 to 14 and Comparative Example 1 are the same as those in Example 1 except the condition of the surface potential V of the casting drum 34.

TABLE 1

| | Surface | Casting |
|---|---|---|
| | Potential V | Speed |
| | (kV) | (m/min) |
| Example 1 | 1.0 | 120 |
| Example 2 | 3.1 | 120 |
| Example 3 | 3.0 | 120 |
| Example 4 | 2.8 | 120 |
| Example 5 | 0.7 | 110 |
| Example 6 | 0.2 | 100 |
| Example 7 | 0.1 | 95 |
| Example 8 | −0.1 | 95 |
| Example 9 | −0.2 | 100 |
| Example 10 | −0.7 | 110 |
| Example 11 | −1.0 | 120 |
| Example 12 | −2.8 | 120 |
| Example 13 | −3.0 | 120 |
| Example 14 | −3.1 | 120 |
| Comparative Example 1 | 0 | 90 |

In Comparative Example 1, at the dope casting speed of as slow as 90 m/min, occurrence of the phenomenon of air entrainment was confirmed. The casting speed of the dope is approximately 90 m/min at most in conventional methods. However, it was confirmed from the result in Example 1 that it is possible to make the casting speed faster up to approximately 110 m/min to 120 m/min without causing the phenomenon of air entrainment in the present invention. Accordingly, it was confirmed that, according to the present invention, since it is possible to speed up the film forming speed to form a casting film having no void and excellent smoothness stably while preventing the occurrence of the phenomenon of air entrainment, it is possible to produce a film having few defects and exhibiting high quality such as excellent smoothness at high speed and stably. Note that in Examples 1 and 14, it was not until the casting speed reaches 120 m/min that the occurrence of the phenomenon of air entrainment was observed, however stepped unevenness was observed in the film at the casting speed of 120 m/min. In view of the above, it is preferable that an absolute value of the surface potential V of the casting drum is set to not less than 1 and not more than 3.

The present invention is not to be limited to the above embodiments, and on the contrary, various modifications will be possible without departing from the scope and spirit of the present invention as specified in claims appended hereto.

What is claimed is:

1. A production method of a polymer film comprising the steps of:
discharging dope containing a polymer and a solvent from a casting die onto a support moving continuously, and casting a bead formed between said casting die and said support onto said support to form a casting film;
drying said casting film peeled from said support as a film; and
charging a surface of said support by a voltage applying device disposed at the vicinity of the surface of said support before formation of said casting film.

2. A production method of a polymer film as defined in claim 1, wherein said voltage applying device is an electrode body for applying charge to said support by discharging toward said support, and is disposed in an upstream side from said bead in a moving direction of said support.

3. A production method of a polymer film as defined in claim 2, wherein an electrical insulating layer is disposed on the surface of said support.

4. A production method of a polymer film as defined in claim 3, wherein surface potential V of said support is set to 0.1 kV≦|V|≦3 kV.

5. A production method of a polymer film as defined in claim 4, wherein said casting is performed under an oxygen concentration of less than 10 wt %.

6. A production method of a polymer film as defined in claim 5, wherein a suction chamber provided in an upstream side from said bead decompresses a portion in the upstream side from said bead.

7. A production method of a polymer film as defined in claim 6, wherein said electrical insulating layer has a multi-layer structure.

8. A production apparatus of a polymer film comprising:
a support moving continuously;
a casting die for discharging a dope containing a polymer and a solvent onto said support to form a casting film;
a voltage applying device for charging a surface of said support to be cast, said voltage applying device being disposed at the vicinity of the surface of said support; and
a drying device for drying said casting film peeled from said support to form a polymer film.
